(19) United States
(12) Patent Application Publication
(10) Pub. No.: US 2023/0040169 A1
(43) Pub. Date: Feb. 9, 2023

(54) PASSIVE LOAD BALANCER

(71) Applicant: COMMISSARIAT A L ENERGIE ATOMIQUE ET AUX ENERGIES ALTERNATIVES, PARIS (FR)

(72) Inventors: Adrien CHAMBELLAN, IGNY (FR); Xavier LAMY, MEUDON (FR); Alain RIWAN, CHEVILLY-LARUE (FR)

(73) Assignee: COMMISSARIAT A L ENERGIE ATOMIQUE ET AUX ENERGIES ALTERNATIVES, PARIS (FR)

(21) Appl. No.: 17/786,947

(22) PCT Filed: Dec. 14, 2020
(86) PCT No.: PCT/EP2020/085935

§ 371 Date: Jun. 17, 2022

(30) Foreign Application Priority Data
Dec. 20, 2019 (FR) 1915151

(51) Int. Cl. B25J 9/00

(52) U.S. Cl. CPC B25J 9/0006

(57) ABSTRACT

A passive load balancer (1) having a flexible transmission element (60) connected to a hinged arm (10) and to a resilient element (40), a first flexible transmission element deflector (50), and a second flexible element deflector (51), the second flexible element deflector (51) being connected to the structure (2). An exoskeleton including a passive load balancer.

### FIELD OF THE INVENTION

The invention relates to the field of providing assistance in carrying a load, and more particularly to a load balancer that is passive, i.e. that provides a balancing force without any external supply of energy.

### BACKGROUND OF THE INVENTION

Conventionally, a load balancer comprises a structure connected to a user and an arm hinged to the structure about a first axis. A rotary motor connects the structure and the arm together and exerts an active balancing torque on the arm about the first axis. Such a balancer requires electronics for controlling the motor, position and/or force sensors, and an electric battery. Those elements lead to a device that is of limited endurance, and that is heavy and cumbersome. Those drawbacks are hindering the spread of load balancers even though employers are concerned with the issue of reducing the harmfulness of industrial tasks.

### OBJECT OF THE INVENTION

An object of the invention is to improve the ergonomics and/or the endurance of a load balancer.

### SUMMARY OF THE INVENTION

To this end, there is provided a passive load balancer comprising a structure, an arm having a first end hinged to the structure about a first hinge axis, and a resilient element for exerting a balancing torque on the arm about the first axis. According to the invention, the balancer also comprises a flexible transmission element connected at a first connection point to the hinged arm and at a second connection point to the resilient element. A first flexible transmission element deflector is provided for deflecting the flexible transmission element about the first axis. A second flexible transmission element deflector is provided for deflecting the flexible transmission element about a second axis substantially parallel to the first axis, the second flexible transmission element deflector being connected to the structure.

A load balancer is thus obtained that provides a balancing force of magnitude that is constant regardless of the position of the hinged arm. The load balancer is passive, which means that applying the balancing force does not require the supply of any energy, and which also means that the endurance of the balancer is practically unlimited.

It is possible to adjust precisely the magnitude of the compensation for gravity when the balancer includes means for adjusting the position of the first connection point to the hinged arm relative to the hinged arm. This greatly reduces interfering forces, and the transparency of the system is improved when the first connection point comprises a carriage secured to the hinged arm and provided with a first groove and with a second groove in which there extend respectively a first end of a first cable and a second end of the first cable, the first cable also being engaged in a third groove of a spreader to which the flexible element is connected.

The load balancer adapts easily to the orientation of the force that is to be balanced when the balancer includes means for adjusting the position of the second deflector relative to the arm. Such adjustment is made easier when the adjustment means for adjusting the position of the second deflector relative to the arm comprise a plate secured to the second deflector and rotatably mounted about the first axis, together with locking means for locking the plate in position relative to the structure.

Advantageously, the balancer includes adjustment means for adjusting pre-loading of the resilient element.

A particularly economical embodiment is obtained when the resilient element comprises a spring. Safety in operation is then improved when the balancer includes a sheath extending around the spring.

By reducing friction, and thus reducing the nominal power of the resilient element, the weight and the bulk of the balancer are reduced when the first flexible element deflector comprises a first pulley and when the second flexible element deflector comprises a second pulley.

The compactness of the balancer is improved when the means for adjusting pre-loading of the resilient element comprise a nut cooperating with a thread, the nut also being provided with means for preventing it from rotating relative to the thread. A particularly economical embodiment is obtained when the means for preventing the nut from rotating relative to the rod comprise a slot that is made in the sheath and that co-operates with an element secured to the nut.

The invention also applies to an exoskeleton including a load balancer as described above.

Other characteristics and advantages of the invention appear on reading the following description of particular, nonlimiting embodiments of the invention.

### BRIEF DESCRIPTION OF THE DRAWINGS

FIG. 1 is a diagrammatic perspective view of a load balancer of the invention;

FIG. 2 is a diagrammatic perspective view of the FIG. 1 balancer in section on a first plane;

FIG. 3 is a diagrammatic perspective view of the FIG. 1 balancer in section on a second plane orthogonal to the first plane; and

FIG. 4 is a diagrammatic perspective view of an exoskeleton of the invention.

### DETAILED DESCRIPTION OF THE INVENTION

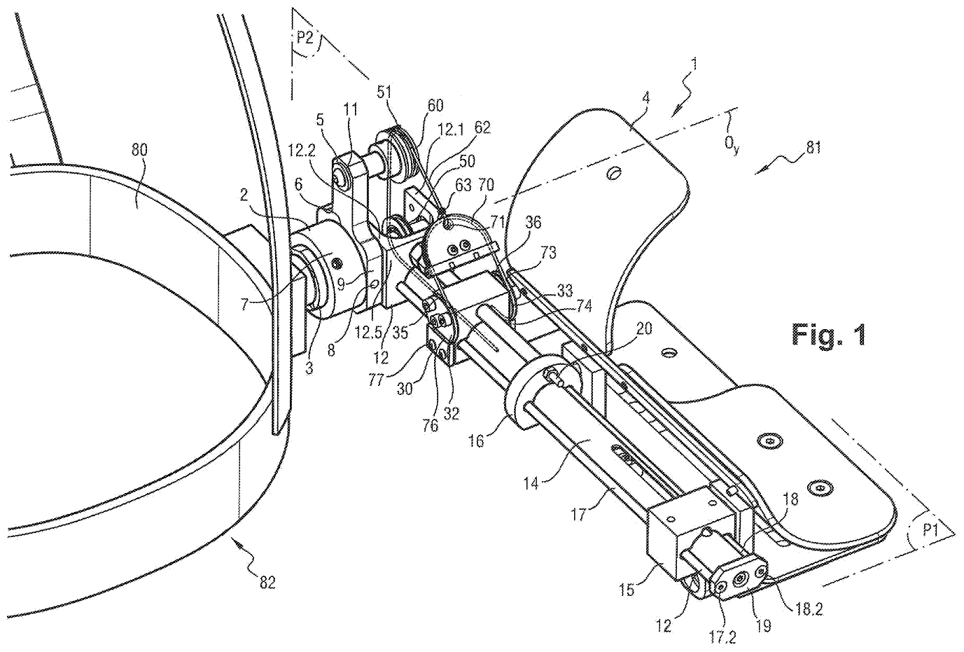

With reference to FIGS. 1 to 3, the passive load balancer of the invention, given overall reference 1, comprises a structure 2 having mounted thereon an arm 10 that has a first end 11 hinged about a first shaft 3 secured to the structure 2 and extending along a first axis Oy. The structure 2 is connected to a chest harness 80 in order to form a left upper limb 81 of a partial exoskeleton 82.

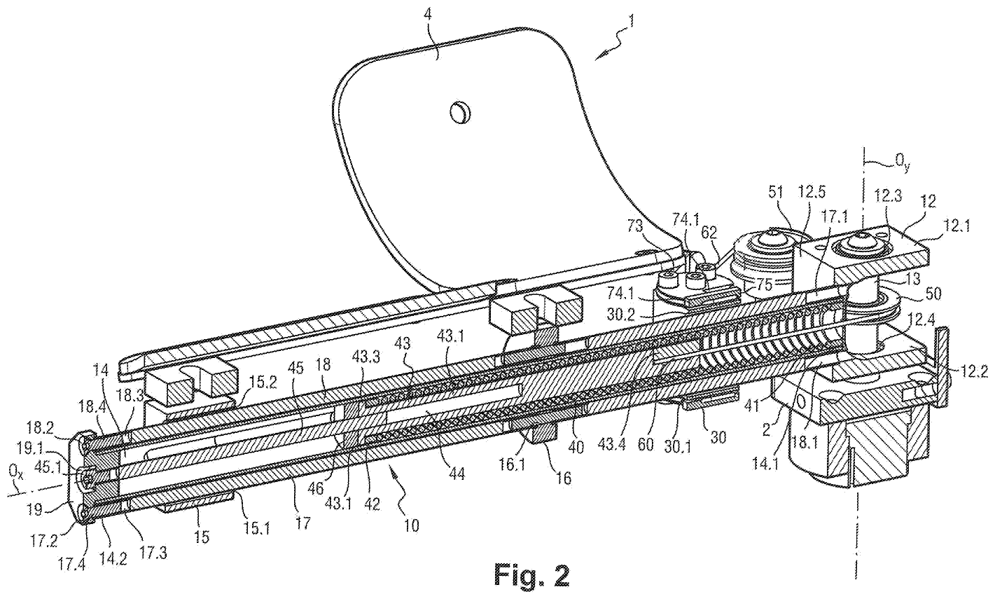

As can be seen in FIG. 2, the arm 10 includes a yoke 12 having a first lug 12.1 and a second lug 12.2 that include respectively a first bearing 12.3 and a second bearing 12.4. The first bearing 12.3 and the second bearing 12.4 receive the first shaft 3. The web 12.5 of the yoke 12 includes a bore 12.6 having a first circular counterbore 12.7. The first end 14.1 of a cylindrical tube 14 is engaged in the first counterbore 12.7 and it extends along a second axis Ox that is substantially orthogonal to the first axis Oy. A first support 15, a second support 16, and a carriage 30 are slidably mounted on the tube 14. A first rod 17 and a second rod 18 extend from the web 12.5 of the yoke 12 parallel to the second axis Ox on opposite sides of the tube 14 and they are secured to a second end 14.2 of the tube 14. The first rod 17 has a first proximal end 17.1 welded to the web 12.5 and it extends through a first bore 15.1 in the first support 15, a second bore 16.1 in the second support 16, and a third bore 30.1 in the carriage 30. The second rod 18 has a second proximal end 18.1 welded to the web 12.5 and it extends through a fourth bore 15.2 in the first support 15, a fifth bore 16.2 in the second support 16, and a sixth bore 30.2 in the carriage 30.

A plug 19 closes the second end 14.2 of the tube 14 by means of a first screw 17.2 that co-operates with a first tapped hole 17.3 in the first distal end 17.4 of the first rod 17 and by means of a second screw 18.2 that co-operates with a second tapped hole 18.3 in the second distal end 18.4 of the second rod 18.

The second support 16 includes a third tapped hole 16.3 that receives a fourth screw 16.4 for applying pressure.

An arm support 4 is fastened to the first support 15 and to the second support 16.

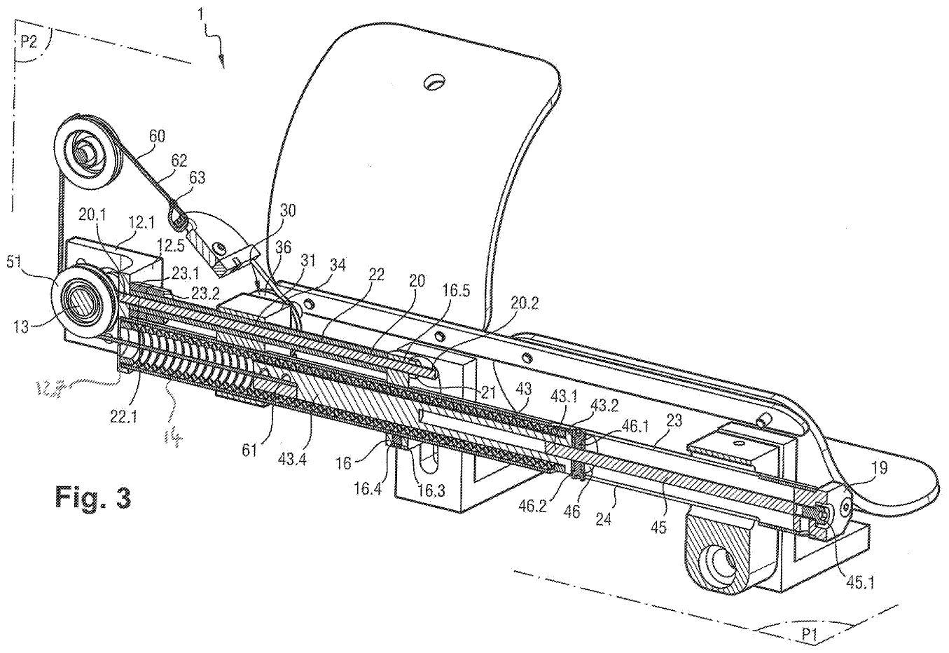

As can be seen in FIG. 3, a third rod 20 extends parallel to the second axis Ox in a second plane P2 orthogonal to the first plane P1 that contains the first rod 17 and the second rod 18. The third proximal end 20.1 of the third rod 20 is welded to the web 12.5 and the third distal end 20.2 of the third rod 20 is threaded and extends through a seventh bore 16.5 in the second support 16. A first nut 21 is engaged on the third distal end 20.2. An externally threaded sleeve 22 is rotatably mounted coaxially on the third rod 20. A second nut 23.1 and a locknut 23.2 are engaged on a fourth proximal end 22.1 of the sleeve 22. The carriage 30 has a fourth threaded hole 31 that co-operates with the sleeve 22.

The carriage 30 has a first cheekplate 32 on the right and a second cheekplate 33 on the left that are screwed to a body 34 of the carriage 30. The first cheekplate 32 has a first groove 35 and the second cheekplate has a second groove 36.

As can be seen in FIGS. 2 and 3, a helical compression spring 40 extends inside the tube 14 along the second axis Ox and has a proximal end 41 bearing against the web 12.5. The distal end 42 of the spring 40 receives a first element 43. The first element 43 has a first portion 43.1 in the form of a right cylinder with a first outside diameter that is substantially less than the inside diameter of the spring 40 and that is engaged inside the spring 40. A distal end 43.2, the first element 43 also has a second portion 43.3 that is in the form of a disk with an outside diameter that is substantially equal to the inside diameter of the tube 14 and that bears against the distal end 42 of the spring 40. The first element 43 also has an eighth bore 44 extending along the second axis Ox and having extending therein the shank of a fifth screw 45 having its head 45.1 received in a second counterbore 19.1 of the plug 19. A third nut 46 co-operates with the fifth screw 45 and bears against the second portion 43.3 of the first element 43. The third nut 46 has first and second diametrically-opposite studs 46.1 and 46.2 that cooperate respectively with a first slot 23 and a second slot 24 in the tube 14 so as to prevent the third nut 46 from rotating relative to the tube 14.

The balancer 1 has a first pulley 50 secured to the pin 13 and that extends between the first lug 12.1 and the second lug 12.2. The balancer 1 also has a second pulley 51 rotatably mounted on a plate 5. In this example, the first and second pulleys 50 and 51 are identical in radius. The plate 5 is mounted to rotate about the pin 13 and it possesses a first serrated surface 6 that faces a second serrated surface 7 of the structure 2. A sixth screw 8 in the form of a needle screw is engaged in a ninth bore 9 in the plate 5 in order to bear against the first shaft 3.

As can be seen in FIGS. 2 and 3, a cord 60 is crimped by first crimping 61.1 at its first end 61 to the proximal end 43.4 of the first element 43 and it extends to the first pulley 50.

The cord 60 is deflected by the first pulley 50 towards the second pulley 51. The second pulley 51 deflects the cord 60 towards the arm 10. The second end 62 of the cord 60 is knotted by means of a knot 63 in a first eyelet 71 in a spreader 70. The spreader 70 also has a third groove 72 in which a first cable 73 extends. The first end 74 of the first cable 73 extends in the first groove 35 and is connected to the carriage 30 via second crimping 74.1 held in place by a first strip 75 that is screwed onto the carriage 30. The second end 76 of the first cable 73 extends in the second groove 36 and is connected to the carriage 30 via third crimping 76.1 held in place by a second strip 77 that is screwed onto the carriage 30.

The knot 63 corresponds to a first connection point connecting the cord 60 to the hinged arm 10, and the first crimping 61.1 corresponds to a second connection point to the hinged arm 10.

With reference to FIGS. 1 to 4, there follows a description of the implementation and operation of the exoskeleton 82 of the invention.

In a preliminary step, a technician acts on the fifth screw 45 so as to move the third nut 46 so that it comes to bear against the first element 43. The movement of the third nut 46 compresses the spring 40 and pre-loads it. Once the desired level of pre-loading has been reached (generally based on an estimate of the weight of a user's arm), the technician adjusts the length of the cord 60 and knots the second end 62 on the eyelet 71.

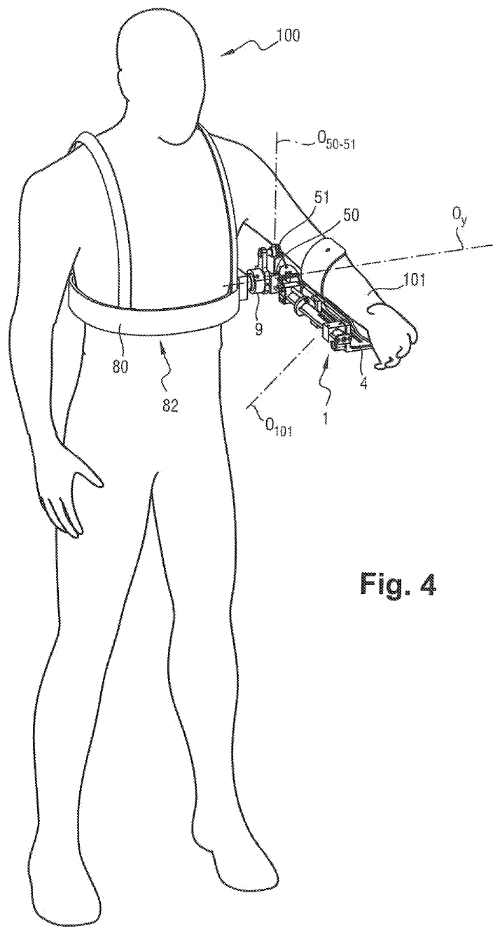

In a first step, the left upper limb 81 of the exoskeleton 82 is put into position on a user 100 by using a chest harness 80 so that the user's left forearm 101 rests on the arm support 4 (FIG. 4). The position of the arm support 4 relative to the user 100 can be adjusted by moving the arm support 4 in translation relative to the arm 10 after loosening the fourth screw 16.4 for applying pressure. The arm support 4 is locked in position on the arm 10 by tightening the fourth screw 16.4 to apply pressure.

In a second step, the sixth screw 8 in the form of a needle screw is then loosened so as to make it possible to separate the first crenellated surface 6 of the plate 5 and the second crenellated surface 7 of the structure 2. The angular position of the second pulley 51 relative to the first pulley 50 about the first axis Oy can then be adjusted freely. This position is adjusted so that the direction O50-51 interconnecting the centers of rotation of the first and second pulleys 50 and 51 is substantially parallel to the direction O101 of the resultant of the forces applied on the load balancer 1 by the arm 101 when in the working position that it is desired to balance. When the balance position is established, the first crenellated surface 6 of the plate 5 and the second crenellated surface 7 of the structure 2 are brought together so that they co-operate and the sixth screw 8 in the form of a needle screw is then tightened.

In a third step, the fifth screw 45 is loosened so as to move the third nut 46 and release the action of the spring 40. The position of the third nut 46 then defines a high abutment for the load balancer 1.

In a fourth step, action is taken on the second nut 23.1 and on the locknut 23.2 to cause the sleeve 22 to turn in order to adjust the distance between the carriage 30 and the web 12.5, thereby adjusting the balance point of the load balancer 1.

Naturally, the invention is not limited to the above description, but covers any variant coming within the ambit of the invention as defined by the claims.

In particular:
although above, the balancer is provided with a chest harness, the invention applies equally to other means for connecting it to a user, e.g. such as a strap or a suit for constituting an exoskeleton that is partial or complete;
although above, the arm includes a tube extending around the spring and that is cylindrical in section, the invention applies equally to other types of sheath for the spring, e.g. a tube that is of section that is square, triangular, oval, or arbitrary;
although above, the balancer includes a compression spring, the invention applies equally to other types of resilient element, e.g. such as a compression spring, a stack of Belleville spring washers, a block of elastomer, a gas or air spring;
although above, the tube is secured to the yoke by means of rods, the invention applies equally to other means for securing the tube to the yoke, e.g. such as brazing, welding, screw fastening, or a force fit;
although above, the rods are secured to the yoke by means of welding, the invention applies equally to other means for securing the rods to the yoke, e.g. such as brazing, screw fastening, or a force fit;
although above, the carriage has cheekplates screwed onto a body, the invention applies equally to other means for providing the carriage with grooves, e.g. such as a welded cheekplate or grooves that are machined directly in the carriage;
although above, the balancer has a first connection element in connection with the spring, the invention applies equally to other means for connecting the resilient element to the cable at a second connection point, e.g. such as a cable clamp or a bent wire clamp;
although above, the pre-loading means comprise a fifth screw, the invention applies equally to other means for providing a screw thread, e.g. such as a threaded rod or a shaft that is threaded completely or in part on its inside face or its outside face;
although above, the load balancer has cable deflection pulleys, the invention applies equally to other means for deflecting the cord, e.g. such as a rotatably mounted shaft, a metal or synthetic eyelet, or a stationary shaft made of low friction material such as bronze or PTFE;
although above, the deflection pulleys are identical in radius, the invention applies equally to deflection pulleys of different radii;
although above, the balancer includes a cord, the invention applies equally to other types of flexible transmission element, e.g. such as any flexible component of solid or tubular section of a shape that may be circular, flat, or other, which flexible element may be made up of sub-elements that are hinged together, e.g. such as a chain or a belt;
although above, both the plate and the structure have respective crenellated surfaces suitable for co-operating selectively, the invention applies equally to other means for adjusting the position of the second deflector relative to the arm, e.g. such as a cotter pin, friction surfaces, assembly by means of slots and dogs, pressure screws, wages, or friction surfaces;
although above, the cord is fastened to the first element by crimping, the invention applies equally to other means for providing the second connection point with the resilient element, e.g. such as a weld, a knot, a cable clamp, or round turns;
although above, the cord is fastened to the spreader by a knot, the invention applies equally to other means for providing the first connection point with the arm, e.g. such as crimping, a weld, a cable clamp, or round turns;
although above, the cord is connected to the arm by means of a spreader having one inlet and two outlets, the invention applies equally to other types of first connection between the cord and the arm, e.g. such as a spreader having one inlet and four outlets, or a direct connection without a spreader, or a single crimp splitting the cord into two strands;
although above, implementing the exoskeleton and adjusting it are described as comprising a particular succession of steps, the invention applies equally to the steps being in some other order, e.g. adjusting the arm carrier before fitting on the user;
although above, the first and second grooves in the carriage receive respectively the first and second ends of the same cable, the invention applies equally to other configurations, e.g. such as a first groove that receives the end of a first cable and a second groove that receives a second end of a second cable, the first and second cables being secured to the spreader;
although above, the load balancer is positioned on the user in such a manner that the user's left forearm rests on the arm support, the invention applies equally to a load balancer positioned on the user's upper arm.

1. A passive load balancer comprising:
a structure;
an arm having a first end hinged to the structure about a first hinge axis (Oy); and
a resilient element for exerting a balancing torque on the arm about the first axis (Oy);
the passive load balancer further comprising:
a flexible transmission element connected at a first connection point to the hinged arm and at a second connection point to the resilient element;
a first flexible transmission element deflector for deflecting the flexible transmission element about the first axis (Oy); and
a second flexible transmission element deflector for deflecting the flexible transmission element about a second axis substantially parallel to the first axis (Oy), the second flexible transmission element deflector being connected to the structure;
the load balancer being characterized in that it includes adjustment means for adjusting the position of the second deflector relative to the hinged arm.

2. A passive load balancer according to claim 1, including adjustment means for adjusting the position of the first connection point with the hinged arm relative to the hinged arm.

3. A passive load balancer according to claim 1, wherein the first connection point comprises a carriage secured to the hinged arm and provided with a first groove and with a second groove in which there extend respectively a first end of a first cable and a second end of the first cable, the first cable also being engaged in a third groove of a spreader to which the flexible transmission element is connected.

4. A passive load balancer according to claim 1, wherein the adjustment means for adjusting the position of the second deflector relative to the hinged arm comprise a plate secured to the second deflector and rotatably mounted about the first axis (Oy), together with locking means for locking the plate in position relative to the structure.

5. A passive load balancer according to claim 1, including adjustment means for adjusting pre-loading of the resilient element.

6. A passive load balancer according to claim 1, wherein the resilient element comprises a spring.

7. A passive load balancer according to claim 6, including a sheath extending around the spring.

8. A passive load balancer according to claim 1, wherein the first flexible element deflector comprises a first pulley and wherein the second flexible element deflector for deflecting the flexible element comprises a second pulley.

9. A passive load balancer according to claim 5, wherein the means for adjusting pre-loading of the resilient element comprise a nut cooperating with a thread, the nut also being provided with means for preventing it from rotating relative to the thread.

10. A passive load balancer according to claim 7, wherein the means for preventing the nut from rotating relative to the thread comprise a slot that co-operates with an element that is secured to the nut.

11. An exoskeleton including a passive load balancer according to claim 1.
